(19) United States
(12) Patent Application Publication
(10) Pub. No.: US 2026/0042217 A1
(43) Pub. Date: Feb. 12, 2026

(54) SAFE AND FAST TELEOPERATED CONTROL OF ROBOT MANIPULATOR WITH AUGMENTED HUMAN-IN-THE-LOOP

(71) Applicant: CONTORO INC., Austin, TX (US)

(72) Inventors: Youngmok Yun, Austin, TX (US); Rohit John Varghese, Austin, TX (US); Mincheol Kim, Austin, TX (US); Daniel Sposito, Pflugerville, TX (US); Kevin Warburton, Austin, TX (US); Michael Normand, Austin, TX (US)

(21) Appl. No.: 19/291,386

(22) Filed: Aug. 5, 2025

Related U.S. Application Data
(60) Provisional application No. 63/680,117, filed on Aug. 7, 2024.

(51) Int. Cl. B25J 9/16

(52) U.S. Cl. CPC B25J 9/1689

(57) ABSTRACT

An embodiment provides an implementation of constraints on a teleoperated system applied directly to the teleoperated robot. In conventional systems, the teleoperating operator receives feedback from the response of the teleoperated robot to the constraint. In the embodiment, however, the constraint engine initiates constraining feedback commands to the teleoperator simultaneously with its commands to the teleoperated robot. This solves a problem of latency in feedback to the operator by (a) eliminating the time taken for the robot to physically react to the constraints which is what would ordinarily trigger feedback to the teleoperator and (b) by cutting at least one step in the communication path, going directly from the constraint engine to the teleoperator instead of conventional systems that go from the constraint engine to the robot to the teleoperator. Other embodiments are described herein.

### CROSS-REFERENCE TO RELATED APPLICATION

This application claims priority to U.S. Provisional Patent Application No. 63/680,117 filed on Aug. 7, 2024 and entitled “Safe and Fast Teleoperated Control of Robot Manipulator With Augmented Human-In-The-Loop”, the content of which is hereby incorporated by reference.

### BACKGROUND

Robot teleoperation is the process of remotely controlling a robot or robotic system in real-time, allowing an operator to perform tasks from a distance. This involves transmitting commands from the operator to the robot and receiving sensory feedback, such as visual, auditory, and haptic information, to guide the robot's actions. Teleoperation is used in various fields, including medical surgery, industrial automation, hazardous environment exploration, and space missions, enabling precise and safe manipulation in environments that are inaccessible or dangerous for humans.

Haptic feedback in teleoperation systems significantly enhances user interaction by providing tactile information that improves precision, control, and situational awareness. It reduces cognitive load by distributing sensory input and increases efficiency and safety by enabling quick responses to environmental changes. This technology is essential for delicate tasks in fields such as medical surgery, industrial automation, space and underwater exploration, and more. By adding a realistic sense of touch, haptic feedback makes remote and virtual interactions more immersive and effective, facilitating better learning and training experiences and improving overall performance in complex tasks.

Constraints on the robotics system are essential for enhancing performance, safety, and efficiency. There are several form of constraints, such as workspace limits and speed/force restrictions, emergency stop mechanisms and collision detection systems that prevent damage and ensure safe operations. Others such as task-specific protocols and energy management, optimize the robot's performance.

### BRIEF DESCRIPTION OF THE DRAWINGS

Features and advantages of embodiments of the present invention will become apparent from the appended claims, the following detailed description of one or more example embodiments, and the corresponding figures. Where considered appropriate, reference labels have been repeated among the figures to indicate corresponding or analogous elements.

FIG. 1A depicts a process with a constraint engine that initiates constraining feedback commands to the teleoperator simultaneously with its commands to the teleoperated robot. FIG. 1B provides pseudocode for implementing the process of FIG. 1A.

FIG. 2A depicts a process where a teleoperator can give signals to command relaxing/tightening of the constraints to the constraint engine, which will then communicate to the robot updated velocity constraints. FIG. 2B provides pseudocode for implementing the process of FIG. 2A.

FIG. 3A depicts a process with a teleoperation helper that enables shared autonomy to complete sub-tasks faster or more accurately than they would be with pure teleoperation. FIG. 3B provides pseudocode for implementing the process of FIG. 3A.

FIG. 4A discloses a network topology showing hybrid paths of communication, with a cloud server mediated peer-to-peer connection for critical low-latency communication for teleoperation and a cloud based path for all other data. FIG. 4B provides pseudocode for implementing the process of FIG. 4A.

FIG. 5 is an example of an industrial robotic arm with a vacuum gripper on the end effector, which is one embodiment of a teleoperated robot.

FIG. 6 provides examples of systems that can be used to teleoperate a robot.

FIGS. 7A-7C provide live 3D reconstructions of teleoperated robot rendered as part of the operator interface which is described in FIGS. 1A-3B.

FIGS. 8A-8D addresses a teleoperation helper described in FIG. 3A.

FIGS. 9-11 provide systems for implementing the embodiments of FIGS. 1A-8D.

### DETAILED DESCRIPTION

Reference will now be made to the drawings wherein like structures may be provided with like suffix reference designations. In order to show the structures of various embodiments more clearly, the drawings included herein are diagrammatic representations of structures. Thus, the actual appearance of the fabricated structures, for example in a photo, may appear different while still incorporating the claimed structures of the illustrated embodiments (e.g., walls may not be exactly orthogonal to one another in actual fabricated devices). Moreover, the drawings may only show the structures useful to understand the illustrated embodiments. Additional structures known in the art may not have been included to maintain the clarity of the drawings. For example, not every layer of a device is necessarily shown. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Phrases such as “comprising at least one of A or B” include situations with A, B, or A and B.

Applicant determined latency in teleoperation poses significant challenges by creating delays between the operator's commands and the robot's actions, leading to reduced control precision and responsiveness. This time lag can cause difficulties in performing tasks, increasing the likelihood of errors or accidents. It also affects the feedback loop, making it challenging to provide real-time sensory information such as visual or haptic feedback, which is crucial for accurate and safe operation.

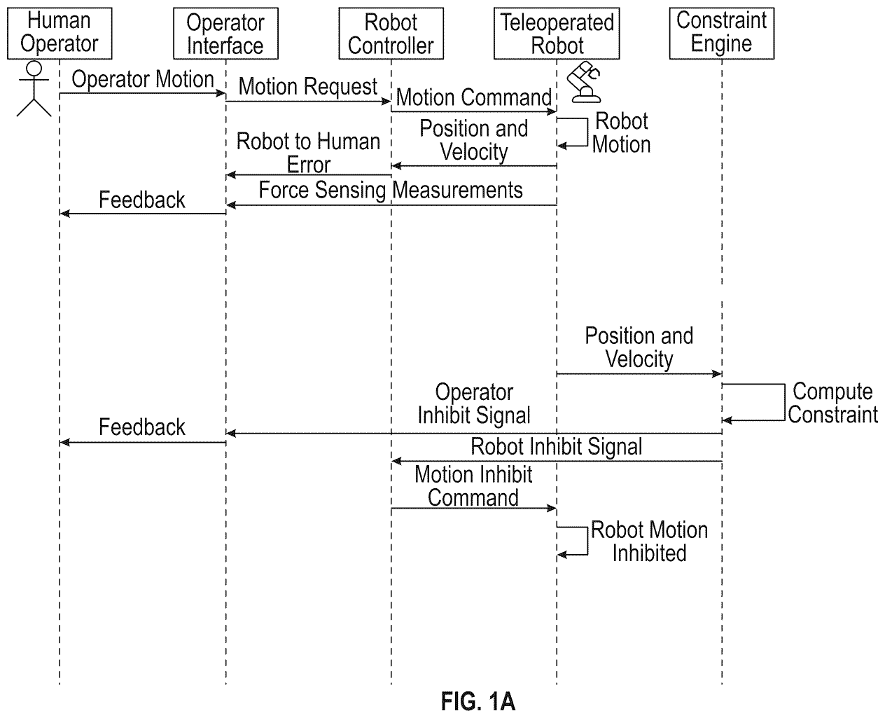

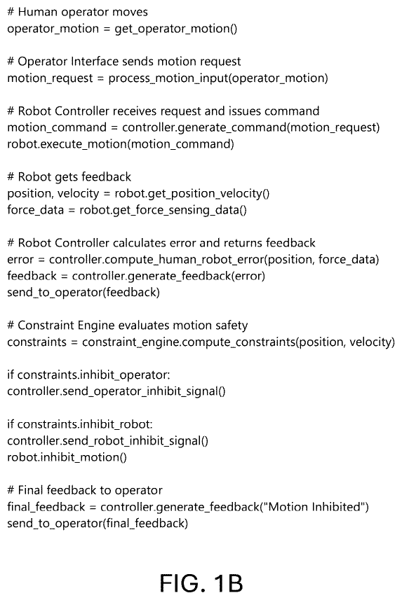

An embodiment provides an implementation of constraints on a teleoperated system applied directly to the teleoperated robot. In conventional systems, the teleoperating operator receives feedback from the response of the teleoperated robot to the constraint. In the embodiment, however, the constraint engine initiates constraining feedback commands to the teleoperator simultaneously with its commands to the teleoperated robot. This solves a problem of latency in feedback to the operator by (a) eliminating the time taken for the robot to physically react to the constraints which is what would ordinarily trigger feedback to the teleoperator and (b) by cutting at least one step in the communication path, going directly from the constraint engine to the teleoperator instead of conventional systems that go from the constraint engine to the robot to the teleoperator. See, for example, FIGS. 1A-1B.

Regarding FIG. 1A, the top part of the messaging diagram shows a teleoperation system with feedback. Traditional teleoperation systems typically provide feedback primarily from the force sensing measurements. However, an embodiment provides several advantages over conventional systems. First, the embodiment of FIGS. 1A-1B includes feedback from error between the robot and the human. Second, the lower section of the messaging diagram provides constraint engine that sends a simultaneous signal sent to constrain the robot as well as to give feedback to the teleoperator. This results in simultaneous inhibiting of both the operator and the robot motion, whereas conventional systems often just bring the robot to an error state if it comes too close to a constrain violation (e.g., collision).

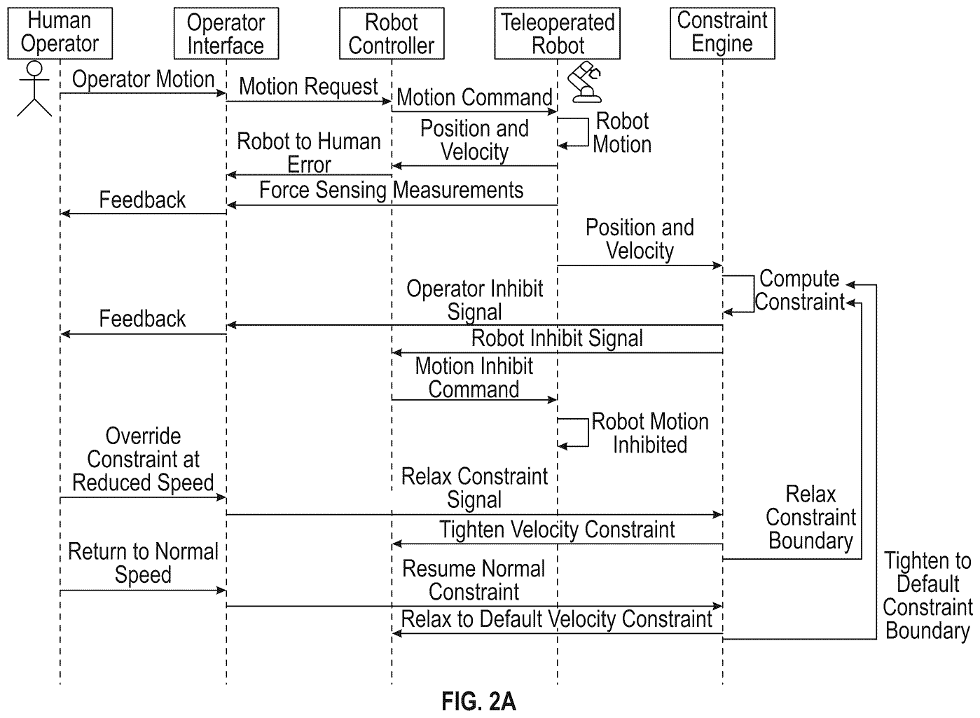

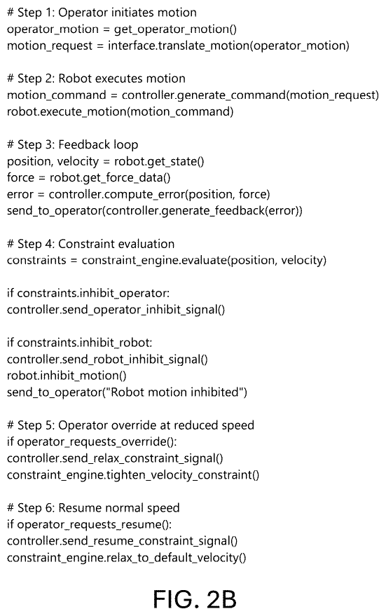

An embodiment provides a means for the teleoperator to signal a relaxation of the position constraints on the robot, which simultaneously caps the maximum velocity of the robot, in comparison to conventional systems that may at best impose fixed constraints only on the teleoperated robot. This solves the problem of constraints reducing the usable workspace of the teleoperated robot to ensure safety at higher velocities. By enabling the teleoperator to relax the constraints, the invention helps ensure the ability of a skilled operator to handle edge cases that a broad constraint rule would otherwise prevent. See, for example, FIGS. 2A-2B.

FIG. 2A is an expansion on FIG. 1A and illustrates where a teleoperator can give signals to command relaxing/tightening of the constraints to the constraint engine, which will then communicate to the robot updated velocity constraints.

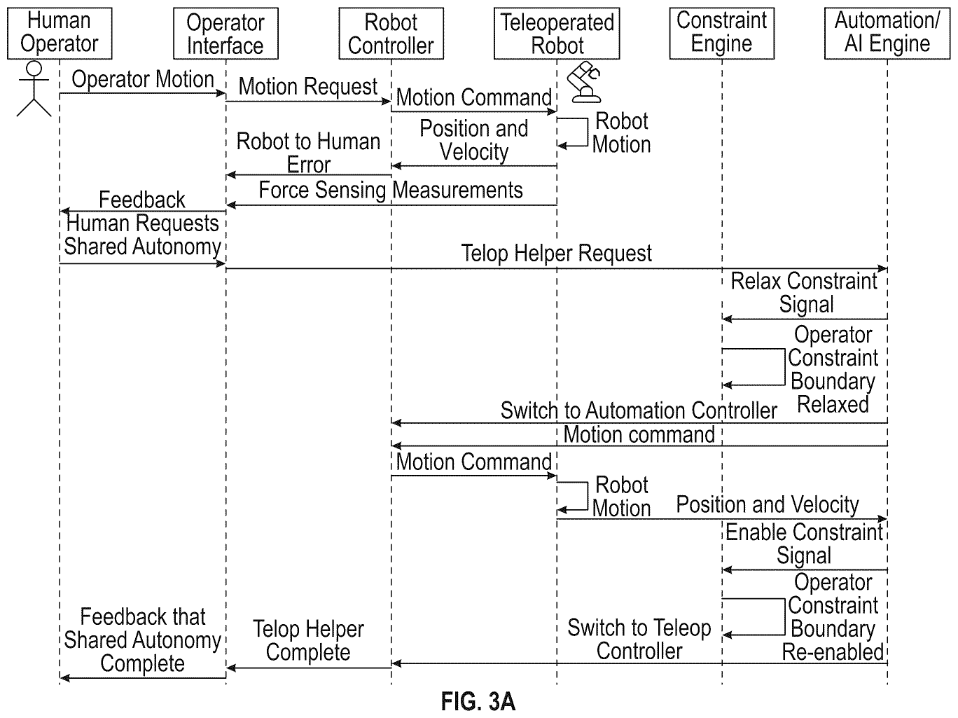

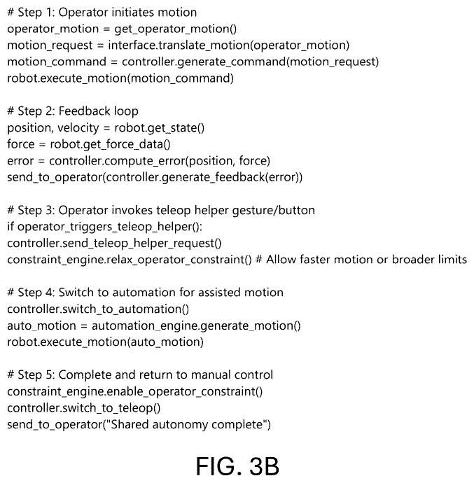

An embodiment provides a teleoperation helper, which is a shared autonomy system that takes a signal with parameters from the teleoperator to autonomously complete a sub-task of the teleoperation. On receiving the signal, the AI automation system changes control of the robot controller to complete the sub-task and then return control to the teleoperator. This improves over the prior art by enabling the teleoperator to share control and request automation to complete sub-tasks that would otherwise be slower if performed by pure teleoperation. See, for example, FIGS. 3A-3B.

FIG. 3A expands on FIG. 1A and shows a teleoperation helper that enables shared autonomy to complete sub-tasks faster or more accurately than they would be with pure teleoperation.

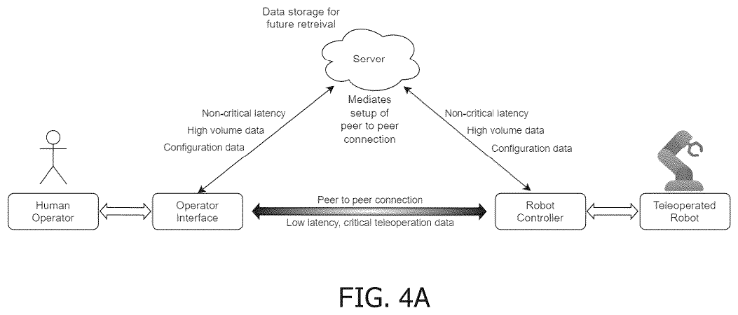

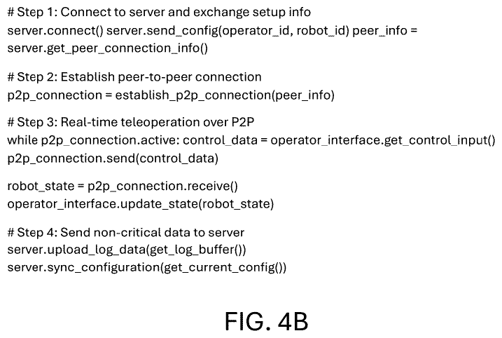

An embodiment is a hybrid network topology used. A cloud server mediated peer-to-peer connection ensures low latency for the critical signals required for real-time teleoperation, while all other data is transmitted via the cloud server at a lower priority to the critical signals. This helps improve latency and improves over prior art that operates over cloud servers, or only uses a pure peer-to-peer network. See, for example, FIGS. 4A-4B.

FIG. 4A discloses a network topology showing hybrid paths of communication, with a cloud server mediated peer-to-peer connection for critical low-latency communication for teleoperation and a cloud based path for all other data.

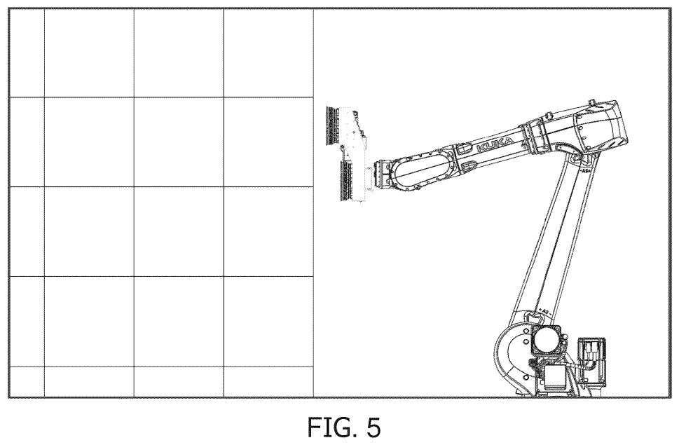

FIG. 5 is an example of an industrial robotic arm with a vacuum gripper on the end effector, which is one embodiment of a teleoperated robot.

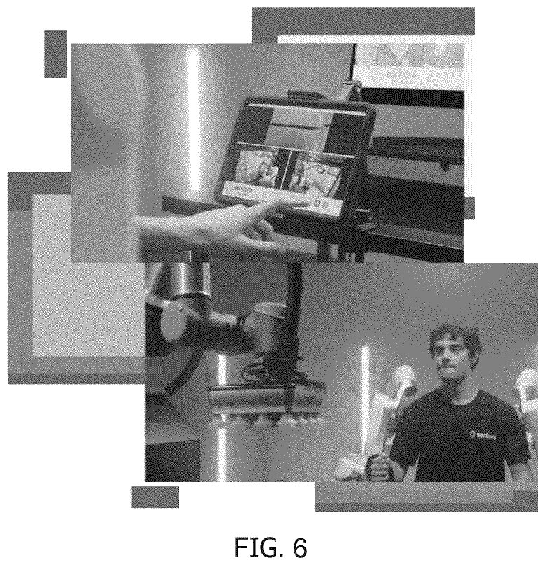

FIG. 6 provides examples of systems that can be used to teleoperate a robot. (Top) controlling through a screen-based UI and (bottom) controlling with an exoskeleton coupled to the teleoperator for haptic feedback.

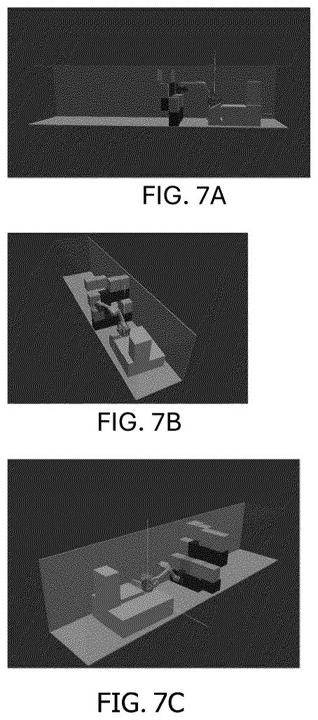

FIGS. 7A-7C provide live 3D reconstructions of teleoperated robot rendered as part of the operator interface which is described in FIGS. 1A-3B.

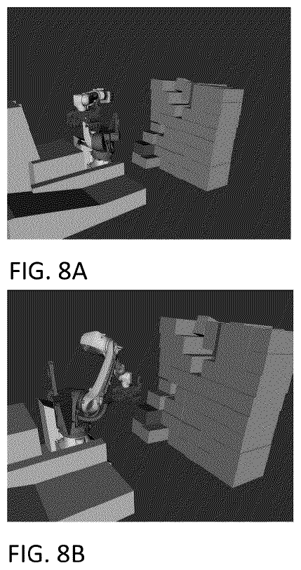

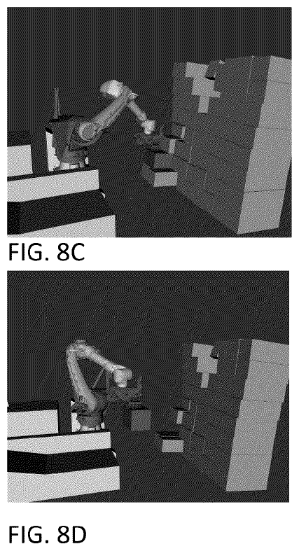

FIGS. 8A-8D addresses a teleoperation helper described in FIG. 3A. FIG. 8A shows the robot in a position where the AI motion planner had failed to reach the target highlighted box. FIG. 8B shows the position after the teleoperation helper has completed moving to a location close to the box. FIG. 8C shows the position after the robot has been teleoperated to make contact. FIG. 8D shows the robot part way through its autonomous motion after autonomy has been handed back.

Embodiments addressed herein provide some or all of the following advantages. First, reduction of latency when teleoperating a robot. See, for example, FIG. 1. Second, the presence of constraints to the teleoperated system enable guardrails to allow human errors or communication lags to not cause damage at the teleoperated site. See, for example, FIG. 2. Third, embodiments enable situational control of the constraints to not limit functionality in edge cases where needed. See, for example, FIG. 2.

### Example

Teleoperated control of a robot may be used to, for example, unload boxes in a shipping container.

Teleoperation is an intervention technique used for control when primary autonomy fails, and is used to guide the robot to complete its task while also to provide training data for future similar instances. The human teleoperator is located outside the robot workcell (in this example, the shipping container) often at a completely different site, and communicates remotely with the robot via the operator interface.

In this example, there are several target objects to pick that can be very close to the walls of the container, and errors in commanded robot position run the risk of hitting the walls and damaging the robot. There are many possible sources of this error, ranging from network latencies (partially addressed in FIGS. 4A-4B), visualization difficulties from limited camera views (partially addressed in FIGS. 7A-7C), and general difficulties in remotely controlling a robot's movement (which can be partially addressed by different master interfaces shown in FIG. 6). None of the above mitigations fully eliminate the risk of collision, which is why the “constraint engine” (Introduced in FIGS. 1A-1B) is used.

The constraint engine uses the robot's sensing capabilities along with models of its kinematics to predict regions of likely collisions, and apply a constraint buffer space preventing the robot from moving near the collision zones. (FIGS. 1A-1B) This constraint engine applies simultaneously to directly limit the robot motion as well as on the operator interface to limit the operator's ability to drive the robot towards the collision.

However, there are instances where the robot tasks (in this case picking a box) require the robot to operate close to the zone of collision (i.e., the robot needs to enter the constraint buffer space that the constraint engine prevents it from entering). In these limited instances, the operator can command the constraint engine to relax the constraints by narrowing the buffer zone. (FIGS. 2A-2B). However, to maintain safe operation, the constraint engine limits or inhibits the robot's speed when in this mode. Once the need to operate close to the collision zone is complete, the operator can command the constraint engine to tighten the constraints again and return to controlling at the uninhibited speed.

An embodiment also covers a teleoperation helper (e.g., FIGS. 3A-3B and FIG. 8) which is a mode of shared autonomy by which the operator can allocate deterministic sub-tasks back to the primary autonomy AI, and only perform direct control where strictly necessary. The teleoperation helper can be used to move faster than a teleoperator would normally be able to control during the sub-tasks that are more easily defined. It can also be used as a mechanism to safely exit the constrained buffer zone either for the operator to reset their movement (in order to attempt from a different approach) or as a staged way to return control to the primary autonomy AI when the next steps of the task are within its capability under supervision.

While the above example covers a use case of a robot picking boxes inside a shipping container, the same principle can be extended to several other examples. An example includes a robot moving boxes within a workcell that could be in a logistics warehouse or a manufacturing facility. An example includes a robot performing pick and place activities in other locations.

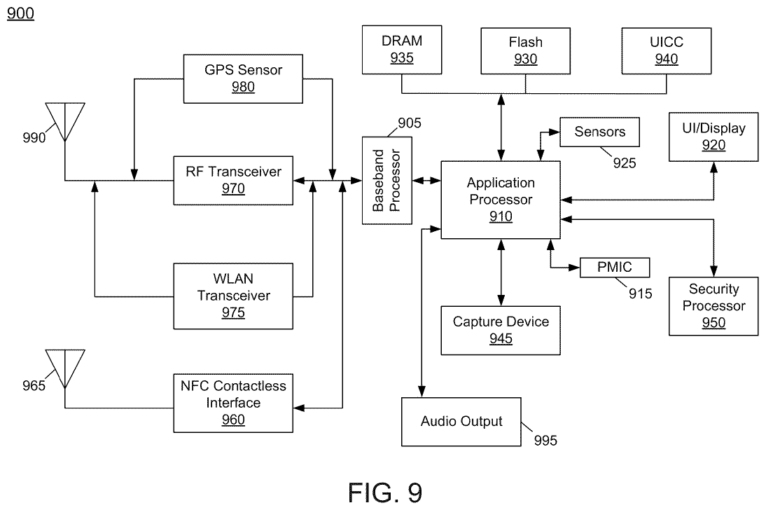

FIG. 9 includes a block diagram of an example system with which embodiments can be used. As seen, system 900 may be a smartphone or other wireless communicator or any other Internet of Things (IoT) device. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920 (e.g., touch screen display). In addition, application processor 910 may couple to a memory system including a non-volatile memory, namely a flash memory 930 and a system memory, namely a DRAM 935. As further seen, application processor 910 also couples to a capture device 945 such as one or more image capture devices that can record video and/or still images.

A universal integrated circuit card (UICC) 940 comprises a subscriber identity module, which in some embodiments includes a secure storage to store secure user information. System 900 may further include a security processor 950 (e.g., Trusted Platform Module (TPM)) that may couple to application processor 910. A plurality of sensors 925, including one or more multi-axis accelerometers may couple to application processor 910 to enable input of a variety of sensed information such as motion and other environmental information. In addition, one or more authentication devices may be used to receive, for example, user biometric input for use in authentication operations.

As further illustrated, a near field communication (NFC) contactless interface 960 is provided that communicates in a NFC near field via an NFC antenna 965. While separate antennae are shown, understand that in some implementations one antenna or a different set of antennae may be provided to enable various wireless functionalities.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more internet of things (IoT) networks, various circuits may be coupled between baseband processor 905 and antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 5G wireless communication protocol such as in accordance with a code division multiple access (CDMA), global system for mobile communication (GSM), long term evolution (LTE) or other protocol. In addition a GPS sensor 980 may be present, with location information being provided to security processor 950. Other wireless communications such as receipt or transmission of radio signals (e.g., AM/FM) and other signals may also be provided. In addition, via WLAN transceiver 975, local wireless communications, such as according to a Bluetooth™ or IEEE 802.11 standard can also be realized.

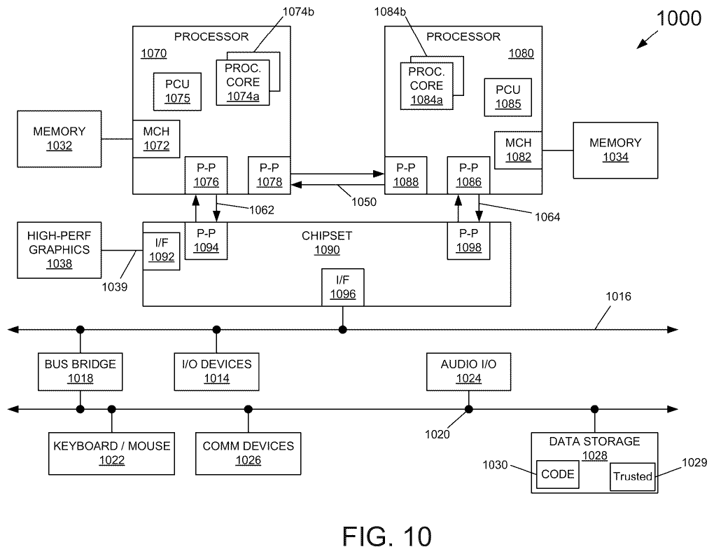

FIG. 10 shows a block diagram of a system in accordance with another embodiment of the present invention. Multiprocessor system 1000 is a point-to-point interconnect system such as a server system, and includes a first processor 1070 and a second processor 1080 coupled via a point-to-point interconnect 1050. Each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include power controller unit 1075 and 1085. In addition, processors 1070 and 1080 each may include a secure engine to perform security operations such as attestations, IoT network onboarding or so forth.

First processor 1070 further includes a memory controller hub (MCH) 1072 and point-to-point (P-P) interfaces 1076 and 1078. Similarly, second processor 1080 includes a MCH 1082 and P-P interfaces 1086 and 1088. MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1062 and 1064, respectively. Chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. Various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio I/O 1024 may be coupled to second bus 1020.

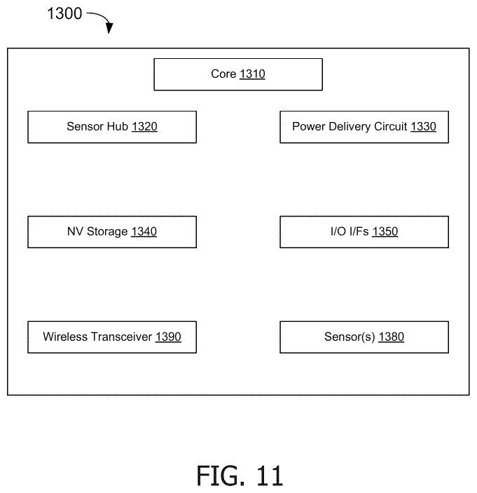

FIG. 11 depicts an IoT environment that may include wearable devices or other small form factor IoT devices. In one particular implementation, wearable module 1300 may be an Intel® Curie™ module that includes multiple components adapted within a single small module that can be implemented as all or part of a wearable device. As seen, module 1300 includes a core 1310 (of course in other embodiments more than one core may be present). Such a core may be a relatively low complexity in-order core, such as based on an Intel Architecture® Quark™ design. In some embodiments, core 1310 may implement a Trusted Execution Environment (TEE). Core 1310 couples to various components including a sensor hub 1320, which may be configured to interact with a plurality of sensors 1380, such as one or more biometric, motion, environmental or other sensors. A power delivery circuit 1330 is present, along with a non-volatile storage 1340. In an embodiment, this circuit may include a rechargeable battery and a recharging circuit, which may in one embodiment receive charging power wirelessly. One or more input/output (IO) interfaces 1350, such as one or more interfaces compatible with one or more of USB/SPI/I2C/GPIO protocols, may be present. In addition, a wireless transceiver 1390, which may be a Bluetooth™ low energy or other short-range wireless transceiver is present to enable wireless communications as described herein. In different implementations a wearable module can take many other forms. Wearable and/or IoT devices have, in comparison with a typical general purpose CPU or a GPU, a small form factor, low power requirements, limited instruction sets, relatively slow computation throughput, or any of the above.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as (a) a computer program product that may include one or more machine readable media having stored thereon instructions that may be used to program a processing system or other electronic device to perform the methods or (b) at least one storage medium having instructions stored thereon for causing a system to perform the methods. The term “machine readable medium” or “storage medium” used herein shall include any medium that is capable of storing or encoding a sequence of instructions (transitory media, including signals, or non-transitory media) for execution by the machine and that cause the machine to perform any one of the methods described herein. The term “machine readable medium” or “storage medium” shall accordingly include, but not be limited to, memories such as solid-state memories, optical and magnetic disks, read-only memory (ROM), programmable ROM (PROM), erasable PROM (EPROM), electrically EPROM (EEPROM), a disk drive, a floppy disk, a compact disk ROM (CD-ROM), a digital versatile disk (DVD), flash memory, a magneto-optical disk, as well as more exotic mediums such as machine-accessible biological state preserving or signal preserving storage. A medium may include any mechanism for storing, transmitting, or receiving information in a form readable by a machine, and the medium may include a medium through which the program code may pass, such as antennas, optical fibers, communications interfaces, and the like. Program code may be transmitted in the form of packets, serial data, parallel data, and the like, and may be used in a compressed or encrypted format. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

### EXAMPLES

### Example 1

At least one non-transitory machine readable medium comprising a plurality of instructions that in response to being executed on a computing device, cause the computing device to perform operations comprising: receiving position and velocity data from a robot, the robot having a robot controller; computing a constraint; in response to computing the constraint, simultaneously communicating: (a) an operator inhibit signal to an operator interface that is coupled to the robot; and (b) a robot inhibit signal to the robot controller.

See, e.g., FIG. 1A.

### Example 2

The at least one medium of example 1, wherein the velocity data is received in response to a human operator causing the operator interface to communicate a motion request to the robot controller.

### Example 3

The at least one medium of example 2, wherein the velocity data is received in response to the robot controller communicating a motion command to the robot.

### Example 4

The at least one medium of example 3, wherein the velocity data is received in response to motion of the robot.

### Example 5

The at least one medium of example 4, the operations comprising communicating a motion inhibit command to the robot in response to communicating the robot inhibit signal to the robot controller.

### Example 6

The at least one medium of example 5, the operations comprising inhibiting motion of the robot in response to communicating the robot inhibit signal to the robot controller.

### Example 7

The at least one medium of example 6, the operations comprising communicating feedback from the operator interface to the human operator in response to communicating the operator inhibit signal to an operator interface.

### Example 8

The at least one medium of example 2, wherein the human operator is at least 100 meters away from the robot.

### Example 9

The at least one medium of example 1, the operations comprising a constraint solver simultaneously communicating: (a) the operator inhibit signal to the operator interface that is coupled to the robot; and (b) the robot inhibit signal to the robot controller.

As used herein, a “constraint engine” is also known as a “constraint solver” from constraint programming. Constraint programming is a paradigm for solving combinatorial problems that draws on a wide range of techniques from artificial intelligence, computer science, and operations research. In constraint programming, users declaratively state the constraints on the feasible solutions for a set of decision variables. Constraints differ from the common primitives of imperative programming languages in that they do not specify a step or sequence of steps to execute, but rather the properties of a solution to be found. In addition to constraints, users also specify a method to solve these constraints. This typically draws upon standard methods like chronological backtracking and constraint propagation, but may use customized code like a problem-specific branching heuristic.

Constraint programming takes its root from and can be expressed in the form of constraint logic programming, which embeds constraints into a logic program.

Instead of logic programming, constraints can be mixed with functional programming, term rewriting, and imperative languages. Programming languages with built-in support for constraints include Oz (functional programming) and Kaleidoscope (imperative programming). Mostly, constraints are implemented in imperative languages via constraint solving toolkits, which are separate libraries for an existing imperative language.

A problem may be modeled with variables, domains, properties, and the like known to those of skill in the art. Software that interprets this model and returns a solution is called a solver or a “constraint solver”. Solvers such as, but not limited to, CP-SAT (open-source CP solver) may be used.

### Example 10

The at least one medium of example 9, wherein communicating the operator inhibit signal to the operator interface does not include communicating the operator inhibit signal to the robot controller.

### Example 11

The at least one medium of example 1, the operations comprising: communicating a relax constraint signal from the operator interface to a constraint solver; in response to communicating the relax constraint signal from the operator interface to the constraint solver, communicating a velocity signal from the constraint solver to the robot controller to decrease a velocity constraint.

See, e.g., FIG. 2A.

### Example 12

The at least one medium of example 11, the operations comprising lowering a constraint boundary of the constraint solver in response to communicating the relax constraint signal from the operator interface to the constraint solver.

### Example 13

The at least one medium of example 11, the operations comprising communicating the relax constraint signal from the operator interface to the constraint solver in response to communicating the operator inhibit signal to the operator interface.

### Example 14

The at least one medium of example 11, wherein the relax constraint signal alters a robot position constraint.

### Example 15

The at least one medium of example 1, the operations comprising: communicating a request from the operator interface to an automation engine; in response to communicating the request from the operator interface to the automation engine, communicating a relax constraint signal from the automation engine to a constraint solver.

See, e.g., FIG. 3A.

An automation engine may include, for example, a motion planning, manipulation, and kinematics framework for a remote operating system (ROS). See, for example, https://moveit.ai/. Motion planning, also path planning (also known as the navigation problem or the piano mover's problem) is a computational problem to find a sequence of valid configurations that moves the object from the source to destination. The term is used in computational geometry, computer animation, robotics and computer games.

### Example 16

The at least one medium of example 15, the operations comprising: in response to communicating the relax constraint signal form the automation engine to the constraint solver, communicating a motion command from the automation engine to the robot controller.

### Example 17

The at least one medium of example 16, the operations comprising: in response to communicating the motion command from the automation engine to the robot controller, communicating an enable constraint signal from the automation engine to the constraint solver.

### Example 18

The at least one medium of example 16, the operations comprising: in response to communicating the relax constraint signal form the automation engine to the constraint solver, communicating an enable constraint signal from the automation engine to the constraint solver.

### Example 19

The at least one medium of example 1, the operations comprising: communicating first data from the operator interface to the robot controller via at least one cloud server; communicating second data from the operator interface to the robot controller via a peer to peer connection.

### Example 20

The at least one medium of example 19, the operations comprising communicating the first data from the operator interface to the robot controller via at least one cloud server simultaneously with communicating the second data from the operator interface to the robot controller via the peer to peer connection.

As used herein, “simultaneously” entails overlap of the communication of the first and second data at some level.

Alternative version of Example 1. At least one non-transitory machine readable medium comprising a plurality of instructions that in response to being executed on a computing device, cause the computing device to perform operations comprising: a constraint engine receiving position and velocity data from a robot, the robot having a robot controller; the constraint engine computing a constraint; in response to computing the constraint, the constraint engine simultaneously communicating: (a) an operator inhibit signal to an operator interface; and (b) a robot inhibit signal to the robot controller.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one non-transitory machine readable medium comprising a plurality of instructions that in response to being executed on a computing device, cause the computing device to perform operations comprising:
receiving position and velocity data from a robot, the robot having a robot controller;
computing a constraint;
in response to computing the constraint, simultaneously communicating: (a) an operator inhibit signal to an operator interface that is coupled to the robot; and (b) a robot inhibit signal to the robot controller.

2. The at least one medium of claim 1, wherein the velocity data is received in response to a human operator causing the operator interface to communicate a motion request to the robot controller.

3. The at least one medium of claim 2, wherein the velocity data is received in response to the robot controller communicating a motion command to the robot.

4. The at least one medium of claim 3, wherein the velocity data is received in response to motion of the robot.

5. The at least one medium of claim 4, the operations comprising communicating a motion inhibit command to the robot in response to communicating the robot inhibit signal to the robot controller.

6. The at least one medium of claim 5, the operations comprising inhibiting motion of the robot in response to communicating the robot inhibit signal to the robot controller.

7. The at least one medium of claim 6, the operations comprising communicating feedback from the operator interface to the human operator in response to communicating the operator inhibit signal to an operator interface.

8. The at least one medium of claim 2, wherein the human operator is at least 100 meters away from the robot.

9. The at least one medium of claim 1, the operations comprising a constraint solver simultaneously communicating: (a) the operator inhibit signal to the operator interface that is coupled to the robot; and (b) the robot inhibit signal to the robot controller.

10. The at least one medium of claim 9, wherein communicating the operator inhibit signal to the operator interface does not include communicating the operator inhibit signal to the robot controller.

11. The at least one medium of claim 1, the operations comprising:
communicating a relax constraint signal from the operator interface to a constraint solver;
in response to communicating the relax constraint signal from the operator interface to the constraint solver, communicating a velocity signal from the constraint solver to the robot controller to decrease a velocity constraint.

12. The at least one medium of claim 11, the operations comprising lowering a constraint boundary of the constraint solver in response to communicating the relax constraint signal from the operator interface to the constraint solver.

13. The at least one medium of claim 11, the operations comprising communicating the relax constraint signal from the operator interface to the constraint solver in response to communicating the operator inhibit signal to the operator interface.

14. The at least one medium of claim 11, wherein the relax constraint signal alters a robot position constraint.

15. The at least one medium of claim 1, the operations comprising:
communicating a request from the operator interface to an automation engine;
in response to communicating the request from the operator interface to the automation engine, communicating a relax constraint signal from the automation engine to a constraint solver.

16. The at least one medium of claim 15, the operations comprising:
in response to communicating the relax constraint signal form the automation engine to the constraint solver, communicating a motion command from the automation engine to the robot controller.

17. The at least one medium of claim 16, the operations comprising:
in response to communicating the motion command from the automation engine to the robot controller, communicating an enable constraint signal from the automation engine to the constraint solver.

18. The at least one medium of claim 16, the operations comprising:
in response to communicating the relax constraint signal form the automation engine to the constraint solver, communicating an enable constraint signal from the automation engine to the constraint solver.

19. The at least one medium of claim 1, the operations comprising:
communicating first data from the operator interface to the robot controller via at least one cloud server;
communicating second data from the operator interface to the robot controller via a peer to peer connection.

20. The at least one medium of claim 19, the operations comprising communicating the first data from the operator interface to the robot controller via at least one cloud server simultaneously with communicating the second data from the operator interface to the robot controller via the peer to peer connection.
